(19) United States
(12) Patent Application Publication
(10) Pub. No.: US 2019/0005082 A1
(43) Pub. Date: Jan. 3, 2019

(54) METHOD AND SYSTEM FOR COMMITTING GROUP ATOMIC TRANSACTION IN NON-RELATIONAL DATABASE

(71) Applicant: Infosys Limited, Bangalore (IN)

(72) Inventors: Vishal Pannala, Hyderabad (IN); Radha Krishna Pisipati, Hyderabad (IN)

(21) Appl. No.: 15/725,929

(22) Filed: Oct. 5, 2017

(30) Foreign Application Priority Data
Jul. 3, 2017 (IN) 201741023280

(51) Int. Cl. G06F 17/30

(52) U.S. Cl. CPC G06F 17/30353; G06F 17/30575

(57) ABSTRACT

The present technique discloses a method and system for committing atomic transaction in NoSQL database by using a transaction manager. The transaction manager is a middle layer between a distributed columnar database and an application accessing the database. The business entity for which data needs to be updated or inserted is identified and concurrency level of that business entity is determined. This concurrency level determines whether all overlapping transaction should be allowed to continue simultaneously or only the transaction which started first should be allowed to continue at a time. The update of business entity data starts from bottom of hierarchical physical tables or from child tables. If any of the child table transaction is unsuccessful then transaction manager aborts transaction at parent level or business entity level. However, if child table transactions are successful then transaction manager commits the transaction at business entity level.

This application claims the benefit of Indian Patent Application Serial No. 201741023280, filed on Jul. 3, 2017, which is hereby incorporated by reference in its entirety.

### FIELD

This invention relates generally to database technologies, and in particular, to a method and system for committing group atomic transaction in non-relational database, more specifically in NoSQL database.

### BACKGROUND

Distributed columnar database systems offer an extreme level of scalability that is not available with other database systems but at the same time restrict the features that application designers have come to expect from any database management system by default. NoSQL database designs are driven by the use case and unlike their relational counterparts, are not driven predominantly by the Information Semantics alone. While most work on distributed transaction management have focused on two phase commit i.e. reduction of network round trips to arrive at a distributed consensus, none have put thought to the application layer semantics of the transaction management problem. Current technologies have been trying to provide all transaction management capabilities like atomicity, consistency, isolation and durability at the database layer or relegate the same to the Business Applications themselves to handle the same. While NoSQL databases provide the BASE (Basically Available, Soft state, Eventual consistency) properties, these alone are not sufficient to guarantee a consistent state in the midst of a complex multi-table transaction or a single table transaction over multiple rows. This is because, most NoSQL databases guarantee atomicity at individual row level but not across rows or tables. Hence, when application layer semantics demand more than the minimum guarantees that these databases provide, these databases steer clear of supporting such requirements.

Existing technologies, products and software fail to recognize the growing and varied needs in terms of the data models being built on top of distributed columnar databases and the application layer transaction semantics and address the problem of transaction management purely from a database management system (DBMS) perspective. They also fail to recognize the fact that application needs are driven by Business entities which may be constituted by a number of smaller database level entities or physical tables. They also do not support the presence of different kind of workloads that the database is subjected to, the different frequencies at which sub-sets of the business entity changes and also the fact that in order to maintain consistency and sanctity of the Business data, a Business entity should either be transacted upon in the whole, or not at all when participating in transactions that may compromise data integrity and consistency.

### SUMMARY

The present invention overcomes the above mentioned drawbacks by building a transaction manager that respects the application use case and design considerations instead of applying a one size fits all approach of the NoSQL databases. The present technique aims to provide this capability for the columnar and distributed databases where application considerations force one to have a business entity stored in more than one table. This invention develops mechanisms for distributed transaction semantics management and builds an application layer that guarantees group atomicity during execution of multi-row transactions. It ensures that a transaction executed on multiple rows in a NoSQL columnar database either executes or fails in entirety and does not leave the database in an inconsistent state.

According to the present embodiment, a method for committing group atomic transaction in non-relational database is disclosed. The method includes identifying a business entity for which data needs to be inserted or updated in the distributed columnar database, wherein the data is stored in multiple hierarchical physical tables. Then, a surrogate key is generated for the business entity. After that, data related to the business entity stored in the multiple hierarchical physical tables are updated by using the surrogate key, wherein the data is updated starting from bottom of the hierarchical physical tables till root of the hierarchical physical tables is reached. Finally, the transaction is committed by inserting the surrogate key and a business key associated with the business entity.

In an additional embodiment, a system for committing group atomic transaction in non-relational database is disclosed. The system includes a memory coupled to one or more processors which are configured to execute programmed instructions stored in the memory including identifying a business entity for which data needs to be inserted or updated in the distributed columnar database wherein the data is stored in multiple hierarchical physical tables, generating a surrogate key for the business entity, updating atomically data related to the business entity stored in the multiple hierarchical physical tables by using the surrogate key wherein the data is updated starting from bottom of the hierarchical physical tables till root of the hierarchical physical tables is reached and committing the transaction by inserting the surrogate key and a business key associated with the business entity.

In another embodiment of the present disclosure, a non-transitory computer readable storage medium for committing group atomic transaction in non-relational database is disclosed. The computer readable storage medium which is not a signal stores computer executable instructions for identifying a business entity for which data needs to be inserted or updated in the distributed columnar database wherein the data is stored in multiple hierarchical physical tables, generating a surrogate key for the business entity, updating atomically data related to the business entity stored in the multiple hierarchical physical tables by using the surrogate key wherein the data is updated starting from bottom of the hierarchical physical tables till root of the hierarchical physical tables is reached and committing the transaction by inserting the surrogate key and a business key associated with the business entity.

### BRIEF DESCRIPTION OF THE DRAWINGS

Various embodiments of the invention will, hereinafter, be described in conjunction with the appended drawings. There is no intention to limit the scope of the invention to such blocks or objects, or to any particular technology. These simplified diagrams are presented by way of illustration to aid in the understanding of the logical functionality of one or more aspects of the instant disclosure and is not presented by way of limitation.

FIG. 1 is a flowchart, illustrating a method for committing atomic transaction in NoSQL database, in accordance with an embodiment of the present invention.

FIG. 2 is an architectural diagram of the system for committing atomic transaction in NoSQL database, in accordance with an embodiment of the present invention.

FIG. 3 is a diagram of a computer system with which the present invention can be implemented.

### DETAILED DESCRIPTION

The foregoing has broadly outlined the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

Exemplary embodiments of the present invention provide a method and system for committing group atomic transaction in non-relational database by using a transaction manager. In a preferred embodiment, this invention is implemented on NoSQL distributed database. The transaction manager is a middle layer between a distributed columnar database and an application accessing the database. The business entity for which data needs to be updated is identified and concurrency level of that business entity is determined. Update data refers to “update or insert” data and refers to “insert” in case of database support versioning. This concurrency level determines if all overlapping transaction should be allowed to continue simultaneously or only the transaction which started first should be allowed to continue at a time. The update of business entity data starts from bottom of hierarchical physical tables or from child tables. If any of the child table transaction is unsuccessful then transaction manager aborts transaction at parent level or business entity level. However, if child table transactions are successful then transaction manager commits the transaction at business entity level.

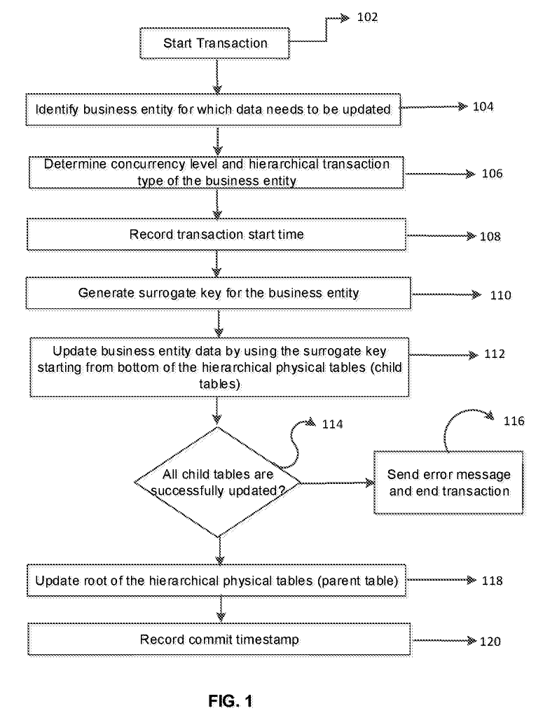

FIG. 1 is a flowchart, illustrating a method for committing atomic transaction in NoSQL database, in accordance with an embodiment of the present invention. The method starts by identifying a business entity for which data needs to be inserted or updated in the distributed columnar database at 104. The data is stored in multiple hierarchical physical tables. Often Application considerations force one to have a Business entity stored in more than one table in case of columnar and distributed databases. For example, a Customer of a large Bank is an entity with a lot of rich attribution and important information. Also, banks want to track a customer across accounts and relationships with the Bank, his Credit Score history, social media interactions that the customer has and his basic profile information. Now, his basic profile information including demographics, his income levels, address and other personal information rarely change. The information is also gleaned from structured data sources. His Credit Rating and other financial information may be obtained from Credit Rating agencies as is the standard practice but changes more frequently than the rest of the information. His social media interactions may again including his friends list, pages of various associations, charitable organizations etc. that he likes. This information is often changing, but not at a regular frequency as the Credit Score and there could be months of inactivity in this case. The information regarding his travels, likes and his influence score on his network (as well as who in his network can potentially influence him) is a piece of information that may be changing much more often than any other piece of information as these metrics are decided based on his interactions on the social media, his response to commercial offerings and recommendations by his friends, etc. In this context, even in a NoSQL data store, it may make sense to divide the information based on the frequency of updates (irrespective of the source) into multiple tables/entities or divide them based on the source of information if the ingestion process needs to be organized well to overcome certain process limitations. Whatever be the case, the Business Entity of Customer may be split across multiple entities to enable better analytics and also apply different algorithms that help us different aspects of the same Customer information. This invention ensures that a transaction executed on multiple rows in a NoSQL columnar database either executes or fails in entirety and does not leave the database in an inconsistent state. During configuration phase, business entities are set-up as hierarchical tables and column groups. For example, business entity “Product” may comprises of hierarchical tables such as ‘Product’ table, ‘Product Attributes’ table, ‘Components’ table, ‘Component Attributes’ etc. The concurrency level and hierarchical transaction type of the business entity are determined at 106. Concurrency level is of two types—a) mutually exclusive locking and b) non-blocking and first finish. In case of mutually exclusive locking, as soon as an overlap of transaction is detected, start timestamps of the overlapping transactions are compared and force abort the transaction that started later. The overlap is detected by recording the transaction start time of all transaction initiated by end user. Contrary to this, in case of non-blocking and first finish, both transactions are allowed to run in parallel till one of them commits first. Hierarchical transaction type may include a) long running transactions and b) immediate transaction. Long running transactions are usually associated with a Business workflow and requires a mutually exclusive lock from the application semantics/Business Requirements perspective. Immediate or regular transactions need start and commit timestamps of overlapping transactions to identify those overlapping transactions and abort an overlapping transaction either based on commit timestamp or start timestamp. The start timestamp is recorded at step 108 to allow only one transaction at a time in case the concurrency level is mutually exclusive locking. A surrogate key for the business entity is generated by using any key generation mechanism at step 110. These keys are non-intelligent and not useful to the Business for any search and retrieval operations. End-users always search with Business Key and not with Surrogate keys. Data related to the business entity stored in the multiple hierarchical physical tables is inserted or updated by using the surrogate key at step 112. This update is done from bottom of the hierarchical physical tables or in another word from child tables and continues till the root of the hierarchical physical tables (or parent table) is updated. Root of the business entity is configured during set-up stage. The surrogate keys are inserted or updated atomically for the proposed column group. It is to be noted that surrogate for a level is concatenation of the surrogate keys of all its proceeding level above along with a delimiter. An exemplary surrogate key may be “aei873oud868821283f!bb873873nkksdkgg” wherein ! is used as delimiter. If any failure occurs during updating of child tables, then transaction is aborted and an error message is sent at step 116. Surrogate keys is generated for the business entity by using any random number generator or using a method named java.util.UUID.randomUUID( ). These are highly random and do not depend on a seed. Any two invocations of the same method are not expected to generate the same number. The example of generating surrogate key is provided for understanding purpose and does not intend to limit the scope of the invention. If no failure is reported, the transaction is committed by inserting the parent surrogate key and the Business key used for retrieving the business entity in question at step 118. Only surrogate keys have been added to establish the hierarchy but no Business key and hence the business entity remains unsearchable or irretrievable and all readers see a consistent state of data even in case of transaction failure. Reader can see update at business entity level only if all transactions till the root of hierarchical physical tables are successful. A batch process runs every few minutes (configurable based on the anticipated activity levels of the database) to identify and purge such orphaned records which do not have the essential business keys or any entry at the root level of the Business entity. This process ensures that the database is cleansed of such incomplete transaction records. Finally, the commit timestamp is recorded at step 120 which is used to block parallel running transactions to be committed once one of these transaction reaches the commit stage if the concurrency level is “non-blocking and first finish”. The inserted Business Key at the top level corresponds to a sequence of surrogate keys present in the lowest level key in a concatenated fashion. The surrogate key at the top level should match the first chunk (before the first delimiter) of the winning transaction.

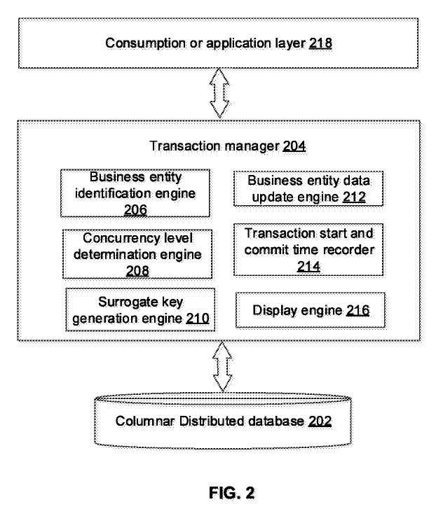

FIG. 2 is an architectural diagram of the system for committing atomic transaction in NoSQL database, in accordance with an embodiment of the present invention. The system comprises of columnar distributed database 202, transaction manager 204 and consumption or application layer 218. Moving transaction manager 204 to middle layer makes it database and application agnostic. Transaction manager 204 does not depend on database 202 and can be modified as per application 218 semantics. Since transaction manager 204 is in middle layer, it 204 can be developed seamlessly without worrying on how database updates handle. Moreover, this clear separation of transaction manager 204 from database layer 202 and application layer 218 allows different application 218 to act differently on the same tables. That is, one application can enforce ‘mutually exclusive locking’ and another application can enforce ‘non-blocking and first finish’. Transaction manager 204 comprises of business entity identification engine 206, concurrency level determination engine 208, surrogate key generation engine 210, business entity data update engine 212, transaction start and commit time recorder 214 and display engine 216. Business entity identification engine 206 is configured to identify a business entity for which data needs to be inserted or updated in the distributed columnar database, wherein the data is stored in multiple hierarchical physical tables. Concurrency level determination engine 208 is configured to determine concurrency level of the identified business entity, wherein the concurrency level comprises “mutually exclusive locking” and “non-blocking and first finish”. Surrogate key generation engine 210 is configured to generate a surrogate key for the business entity. Business entity data update engine 212 is configured to insert or update atomically data related to the business entity stored in the multiple hierarchical physical tables by using the surrogate key, wherein the data is inserted or updated starting from bottom of the hierarchical physical tables till root of the hierarchical physical tables is reached. Transaction start and commit time recorder 214 is configured to record transaction start time of the business entity to allow only one transaction at a time in case the concurrency level is mutually exclusive locking and transaction commit time to block other parallel transactions to be committed in case the concurrency level is non-blocking and first finish. Display engine 216 is configured to show the business entity update to end user. Display engine 216 ensures the business entity appropriateness or completeness and partially committed transactions are not visible even though present in the database till the next scheduled clean-up operation happens. Display engine 216 always uses the Business Key to fetch a business entity and also reads only a consistent set of surrogate keys from the winning transaction in a hierarchical fashion.

The above technique can be explained with a help of an example of updating information of a customer registered with a bank. This example is provided only for understanding purpose and not to limit the scope of the invention. Bank Customer consists of a base “Customer table” including the Customer Name, Address, Social Security number, Tax Identifier, etc. that rarely change. Customer Contact Preferences information may include his telephone, mobile, email and other contact information that can be updated and ordered by his preferred order of contact at any time by the customer, though it is not a frequent event. Customer social media preferences include his friends list, influence scores and so on which change at frequent intervals. The sources from which this information is gleaned is also different and may not be available at the time of customer creation. His Credit Score and other financial ratings calculated by internal and external agencies change at a regular interval and come from yet another source/feed. He may have multiple accounts with the Bank, some on the Liabilities Business while others are on the Assets part of the Bank's Business. Thus, all these information can be stored in different tables. Now, if the customer changes his job and moves to another location, then his information needs to be updated in Bank database. The hierarchy of tables which need to be updated are “Customer table” (root level table), “Customer contact preference table” and “Customer social preference table” (bottom table of the hierarchy). To update the customer information, a surrogate key is generated at the beginning. The Business key for the customer may be “AST-CC-74658”. The surrogate key for this customer may be “hffop237348vd85” which is completely unintelligible and end user never uses it while searching for information about business entity. This surrogate key is inserted in Customer social preference table along with the updated information of the new company he moved to, his new title, new friends that he made in the new city and any other information that the Bank captures. Next, a row is inserted into the Customer contact preference table with his new work phone, work email and other information using the same surrogate key ‘hffop237348vd85’. Finally, his address details and other information that can be allowed to be updated through this transaction are updated against the same surrogate key ‘hffop237348vd85’. Since surrogate keys have been added to establish the hierarchy instead of Business key, the entity remains unsearchable and end users can see a consistent state of data, i.e. all these updates are not visible to the end users. If all these updates are done successfully, then the Business Key (AST-CC-74658) is inserted alongside the surrogate key (‘hffop237348vd85’) while inserting the root table record. Only at this time end user can see the updates regarding the business entity.

The process of updating tables can be explained with another example. Bank may have below data for customer A and customer B.

TABLE 1

| ColumnGroup1: Basic Profile | | | | | ColumnGroup2: Contact Preferences | | | |
|---|---|---|---|---|---|---|---|---|
| | Business | Customer | Marital | | | | Personal | Contact |
| Surrogate ID | Key | name | status | Address | Mobile | Office email | email | order |
| 545jdj484dj48 | CC53421 | Customer A | N | Address 1 | xxxxxxx | customerA@xyz.com | customerA@abc.com | Personal |
| | | | | | | | | email; |
| | | | | | | | | mobile |
| jhf5454545df | HL25879 | Customer B | N | Address 2 | xxxxxxx | customerB@xyz.com | customerB@abc.com | Mobile, |
| | | | | | | | | office |
| | | | | | | | | email |

TABLE 2

| | | | ColumnGroup2: Connections and influence | | | | | |
|---|---|---|---|---|---|---|---|---|
| ColumnGroup1: Identifiers | | | Social | Social | | | | |
| | Social | Social | media | media | Influence | | Eating | |
| Surrogate ID | media 1_id | media 2_id | 1_friends | 2_friends | score | hobbies | out | movies |
| 545jdj484dj48 | Customer A | Customer_A | “fr1”, “fr2” | “fr1”, “fr2” | 56489666 | Ice | $500 | $200 |
| | | | | | | hockey | | |
| jhf5454545df | Customer B | Customer_B | “fr1”, “fr2” | “fr1”, “fr2” | 154645 | Car | $700 | $1000 |
| | | | | | | racing | | |

If Customer A gets married, then the above tables are required to be updated as below:

TABLE 3

| ColumnGroup1: Basic Profile | | | | | ColumnGroup2: Contact Preferences | | | |
|---|---|---|---|---|---|---|---|---|
| | | Customer | Marital | | | Office | Personal | Contact |
| Surrogate ID | Business Key | name | status | Address | Mobile | email | email | order |
| 545jdj484dj48 | CC53421 | Customer A | N | Address 1 | xxxxxxx | customerA@xyz.com | customerA@abc.com | Personal |
| | | | | | | | | email; |
| | | | | | | | | mobile |
| jhf5454545df | HL25879 | Customer B | N | Address 2 | xxxxxxx | customerB@xyz.com | customerB@abc.com | Mobile, |
| | | | | | | | | office |
| | | | | | | | | email |
| 64656565hgh5d27 | | Customer A | Y | Address 1 | xxxxxxx | customerA@xyz.com | customerA@abc.com | Personal |
| | | | | | | | | email; |
| | | | | | | | | mobile |

As shown in Table 3, a new surrogate key is generated for customer A to update the information of his basic profile as well as social media connections. However, business key is not entered in the table. His social media connections are updated as below:

TABLE 4

| | | | ColumnGroup2: Connections and influence | | | | | |
|---|---|---|---|---|---|---|---|---|
| ColumnGroup1: Identifiers | | | Social | Social | | | | |
| | Social | Social | media | media | Influence | | Eating | |
| Surrogate ID | media 1_id | media 2_id | 1_friends | 2_friends | score | hobbies | out | movies |
| 545jdj484dj48 | Customer A | Customer_A | “fr1”, “fr2” | “fr1”, “fr2” | 56489666 | Ice | $500 | $200 |
| | | | | | | hockey | | |
| 64656565hgh5d27 | Customer A | Customer_A | “fr1”, “fr2” | “fr1”, “fr2”, | 56489666 | Ice | $500 | $200 |
| | | | “fr3(wife)” | “fr3(wife)” | | hockey | | |
| jhf5454545df | Customer B | Customer_B | “fr1”, “fr2” | “fr1”, “fr2” | 154645 | Car | $700 | $1000 |
| | | | | | | racing | | |

Once all the tables and respective column groups are updated successfully, then business key is added back to the table 3 so that the update is visible to end users.

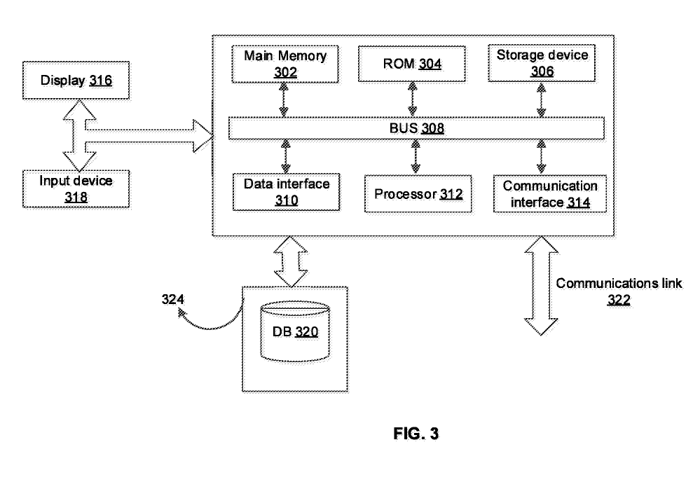

FIG. 3 is a diagram of a computer system with which the present invention can be implemented. In an embodiment of the invention, execution of the sequences of instructions required to practice the invention is performed by a single computer system. According to other embodiments of the invention, two or more computer systems coupled by a communication link 322 may perform the sequence of instructions required to practice the invention in coordination with one another. In order to avoid needlessly obscuring the invention, a description of only one computer system will be presented below; however, it should be understood that any number of computer systems may be employed to practice the invention. Each computer system may include a communication interface 314 coupled to the bus 308. The communication interface 314 provides two-way communication between computer systems. The communication interface 314 of a respective computer system transmits and receives electrical, electromagnetic or optical signals that include data streams representing various types of signal information, e.g., instructions, messages and data. A communication link 322 links one computer system with another computer system. For example, the communication link 322 may be a LAN, in which case the communication interface 314 may be a LAN card, or the communication link 322 may be a PSTN, in which case the communication interface 314 may be an integrated services digital network (ISDN) card or a modem.

A computer system may transmit and receive messages, data, and instructions, including program, i.e., application, code, through its respective communication link 322 and communication interface 314. Received program code may be executed by the respective processor(s) 312 as it is received, and/or stored in the storage device 306, or other associated non-volatile media, for later execution.

In an embodiment, the computer system operates in conjunction with a data storage system 306, e.g., a data storage system 324 that contains a database 320 that is readily accessible by the computer system. The computer system communicates with the data storage system 324 through a data interface 310. A data interface 310, which is coupled to the bus 308, transmits and receives electrical, electromagnetic or optical signals that include data streams representing various types of signal information, e.g., instructions, messages and data. In embodiments of the invention, the functions of the data interface 310 may be performed by the communication interface 314.

Computer system includes a bus 308 or other communication mechanism for communicating instructions, messages and data, collectively, information, and one or more processors 312 coupled with the bus 308 for processing information. Computer system also includes a main memory 302, such as a random access memory (RAM) or other dynamic storage device, coupled to the bus 308 for storing dynamic data and instructions to be executed by the processor(s) 312. The main memory 302 also may be used for storing temporary data, i.e., variables, or other intermediate information during execution of instructions by the processor(s) 312.

The computer system may further include a read only memory (ROM) 304 or other static storage device coupled to the bus 308 for storing static data and instructions for the processor(s) 312. A storage device 306, such as a magnetic disk or optical disk, may also be provided and coupled to the bus 308 for storing data and instructions for the processor(s) 312.

A computer system may be coupled via the bus 308 to a display device 306, such as, but not limited to, a cathode ray tube (CRT), for displaying information to a user. An input device 318, e.g., alphanumeric and other keys, is coupled to the bus 308 for communicating information and command selections to the processor(s) 312.

According to one embodiment of the invention, an individual computer system performs specific operations by their respective processor(s) 312 executing one or more sequences of one or more instructions contained in the main memory 302. Such instructions may be read into the main memory 302 from another computer-usable medium, such as the ROM 304 or the storage device 306. Execution of the sequences of instructions contained in the main memory 302 causes the processor(s) 312 to perform the processes described herein. In alternative embodiments, hard-wired circuitry may be used in place of or in combination with software instructions to implement the invention. Thus, embodiments of the invention are not limited to any specific combination of hardware circuitry and/or software.

The term “computer-usable medium,” as used herein, refers to any medium that provides information or is usable by the processor(s) 312. Such a medium may take many forms, including, but not limited to, non-volatile, volatile and transmission media. Non-volatile media, i.e., media that can retain information in the absence of power, includes the ROM 304, CD ROM, magnetic tape, and magnetic discs. Volatile media, i.e., media that cannot retain information in the absence of power, includes the main memory 302. Transmission media includes coaxial cables, copper wire and fiber optics, including the wires that comprise the bus 308. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

The above mentioned description is presented to enable a person of ordinary skill in the art to make and use the invention and is provided in the context of the requirement for obtaining a patent. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A method, implemented by one or more computing devices, for committing group atomic transaction in a non-relational database by using a transaction manager, wherein the transaction manager is a middle layer between a distributed columnar database and an application accessing the non-relational database, the method comprising:
identifying, by the transaction manager of the one or more computing devices, a business entity for which data needs to be updated in the distributed columnar database, wherein the data is stored in a plurality of hierarchical physical tables;
generating, by the transaction manager of the one or more computing devices, a surrogate key for the business entity;
updating atomically, by the transaction manager of the one or more computing devices, data related to the business entity stored in the plurality of hierarchical physical tables by using the surrogate key, wherein the data is updated starting from bottom of the plurality of hierarchical physical tables till root of the plurality of hierarchical physical tables is reached; and
committing, by the transaction manager of the one or more computing devices, the transaction by inserting the surrogate key and a business key associated with the business entity.

2. The method of claim 1, wherein the non-relational database is a Nosql database.

3. The method of claim 1 further comprising determining a concurrency level of the business entity or a hierarchical transaction type of the business entity.

4. The method of claim 3, wherein the concurrency level comprises a mutually exclusive locking or a non-blocking and first finish.

5. The method of claim 3, wherein the hierarchical transaction type comprises a long running or an immediate transaction.

6. The method of claim 4 further comprising recording a transaction start timestamp or a transaction commit timestamp.

7. The method of claim 6, wherein the transaction start timestamp is used to allow only one transaction at a time in case the concurrency level is the mutually exclusive locking.

8. The method of claim 6, wherein the transaction commit timestamp is used to block other parallel transactions to be committed in case the concurrency level is the non-blocking and first finish.

9. The method of claim 1 further comprising enabling a user to view the update if the transaction is committed till the root of the hierarchical physical tables.

10. The method of claim 1, wherein the transaction is aborted if failure occurs before the root of the hierarchical physical tables is reached.

11. The method of claim 10, wherein an error message is generated for the aborted transaction.

12. The method of claim 1, wherein the root of the hierarchical physical tables is configurable.

13. A system for committing group atomic transaction in a non-relational database by using a transaction manager, wherein the transaction manager is a middle layer between a distributed columnar database and an application accessing the non-relational database, the system comprising:
one or more processors; and
one or more memories operatively coupled to at least one of the one or more processors and having instructions stored thereon that, when executed by at least one of the one or more processors, cause the at least one of the one or more processors to:
identify a business entity for which data needs to be updated in the distributed columnar database, wherein the data is stored in a plurality of hierarchical physical tables;
generate a surrogate key for the business entity;
update atomically data related to the business entity stored in the plurality of hierarchical physical tables by using the surrogate key, wherein the data is updated starting from bottom of the plurality of hierarchical physical tables till root of the plurality of hierarchical physical tables is reached; and
commit the transaction by inserting the surrogate key and a business key associated with the business entity.

14. The system of claim 13, wherein the non-relational database is a Nosql database.

15. The system of claim 13, wherein at least one of the one or more memories has further instructions stored thereon that, when executed by at least one of the one or more processors, cause at least one of the one or more processors to determine a concurrency level of the business entity or a hierarchical transaction type of the business entity.

16. The system of claim 15, wherein the concurrency level comprises a mutually exclusive locking or a non-blocking and first finish.

17. The system of claim 15, wherein the hierarchical transaction type comprises a long running or an immediate transaction.

18. The system of claim 16, wherein at least one of the one or more memories has further instructions stored thereon that, when executed by at least one of the one or more processors, cause at least one of the one or more processors to record a transaction start timestamp or a transaction commit timestamp.

19. The system of claim 18, wherein the transaction start timestamp is used to allow only one transaction at a time in case the concurrency level is the mutually exclusive locking.

20. The system of claim 18, wherein the transaction commit timestamp is used to block other parallel transactions to be committed in case the concurrency level is the non-blocking and first finish.

21. The system of claim 13, wherein at least one of the one or more memories has further instructions stored thereon that, when executed by at least one of the one or more processors, cause at least one of the one or more processors to enable a user to view the update if the transaction is committed till the root of the hierarchical physical tables.

22. The system of claim 13, wherein the transaction is aborted if failure occurs before the root of the hierarchical physical tables is reached.

23. The system of claim 22, wherein an error message is generated for the aborted transaction.

24. The system of claim 13, wherein the root of the hierarchical physical tables is configurable.

25. A non-transitory computer readable medium having stored thereon instructions for committing group atomic transaction in a non-relational database by using a transaction manager, wherein the transaction manager is a middle layer between a distributed columnar database and an application accessing the non-relational database, the non-transitory computer readable medium comprising machine executable code which when executed by at least one processor, causes the at least one processor to perform steps comprising:
identifying a business entity for which data needs to be updated in the distributed columnar database, wherein the data is stored in a plurality of hierarchical physical tables;
generating a surrogate key for the business entity;
updating atomically data related to the business entity stored in the plurality of hierarchical physical tables by using the surrogate key, wherein the data is updated starting from bottom of the plurality of hierarchical physical tables till root of the plurality of hierarchical physical tables is reached; and
committing the transaction by inserting the surrogate key and a business key associated with the business entity.
